(19) United States
(12) Patent Application Publication
(10) Pub. No.: US 2018/0014158 A1
(43) Pub. Date: Jan. 11, 2018

(54) Mobile Device Recommendation System and Method

(71) Applicant: Pulsr Inc., Austin, TX (US)

(72) Inventors: Grant Sinnott Campbell, Austin, TX (US); John Tyler McReynolds, Austin, TX (US); Ivan Jeffery Lay, Austin, TX (US)

(21) Appl. No.: 15/204,386

(22) Filed: Jul. 7, 2016

(51) Int. Cl. H04W 4/02; H04L 29/08; G06Q 50/00; G06Q 30/02; H04M 1/725

(52) U.S. Cl. CPC H04W 4/023; H04L 67/22; H04M 1/72569; G06Q 30/0252; G06Q 50/01; H04M 1/72572

(57) ABSTRACT

A system, method, and computer program product provides recommendations with a mobile device recommendation system to a user of a mobile device. The recommendation system collects data set A comprising ambient sensor data from sensors of a plurality of mobile devices of a selected population located remote from the mobile device of the user. A data set B is also collected over the network wherein data set B comprises social media data transmitted from and/or related to a plurality of venues and/or events located within a selected geographic area. A data set C comprising data received from the user of the mobile device and/or the mobile device of the user is also collected. The data sets A, B, and C are analyzed and a recommendation is provided of at least one of the venues and/or events within the selected geographic area based upon the analyzed data.

### BRIEF DESCRIPTION OF THE DRAWINGS

FIG. 1 is a pictorial representation of network data processing system of a mobile device recommendation system in which illustrative embodiments may be implemented;

FIG. 2 is a block diagram of a data processing system of a mobile device recommendation system in which illustrative embodiments may be implemented;

FIG. 3 is a block diagram of a mobile device in which illustrative embodiments may be implemented;

FIG. 4 is a flowchart of a method of providing recommendations with a mobile device recommendation system to a user of a mobile device in accordance with an illustrative embodiment;

FIG. 5 is a plan view of a mobile device with a display showing an explore screen in which illustrative embodiments may be implemented;

FIG. 6 is a plan view of the mobile device of FIG. 5, with the display showing a details screen in which illustrative embodiments may be implemented;

FIG. 7 is a plan view of the mobile device of FIG. 5, with the display showing a social media feed screen in which illustrative embodiments may be implemented;

FIG. 8 is a plan view of the mobile device of FIG. 5, with the display showing a user page of a collections screen in which illustrative embodiments may be implemented; and

FIG. 9 is a plan view of the mobile device of FIG. 5, with the display showing a friends page of the collections screen of FIG. 8 in which illustrative embodiments may be implemented.

### DETAILED DESCRIPTION OF THE PREFERRED EMBODIMENT

In a mobile device recommendation system and method, data is collected from various sources and an analysis of qualities, attributes, and characteristics of venues and/or events is made. A recommendation of one or more venues and/or events for which there is a likelihood that a user of a mobile device will have interest in or would enjoy can then be provided on the mobile device of the user. The recommendation system and method makes use of social media data and ambient sensor data from sensors of a plurality of mobile devices of a selected population that are located remote from the mobile device of the user. The recommendation system and method further makes use of data received from the user of the mobile device and/or the mobile device of the user.

The embodiments described herein may include a system, method or computer program product. Accordingly, the various embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, certain embodiments may take the form of a computer program product embodied in one or more non-transitory computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be any non-transitory tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computing device, partly on the user's computing device, as a stand-alone software package, partly on the user's computing device and partly on a remote computing device or server or entirely on a remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider).

Aspects of the embodiments may be described with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computing device, special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer device, other programmable data processing apparatus, or other devices to cause a series of operational steps to be performed on the computer device, other programmable apparatus or other devices to produce a computer implemented process such that the instructions which execute on the computer device or other programmable apparatus provide processes for implementing the functions/acts specified in the flowchart and/or block diagram block or blocks.

The schematics, flowchart and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” and/or “consisting of” when used in the detailed description, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The invention can take the form of an entirely hardware embodiment, an entirely software embodiment or an embodiment containing both hardware and software elements. Certain embodiments may be implemented in software, which includes but is not limited to firmware, resident software, microcode, etc. The software may be preinstalled on a mobile device or other devices or it may be downloaded or otherwise received by a mobile device or other devices through network or other source.

Furthermore, certain embodiments of the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, touchscreens, cameras, microphones, speakers, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

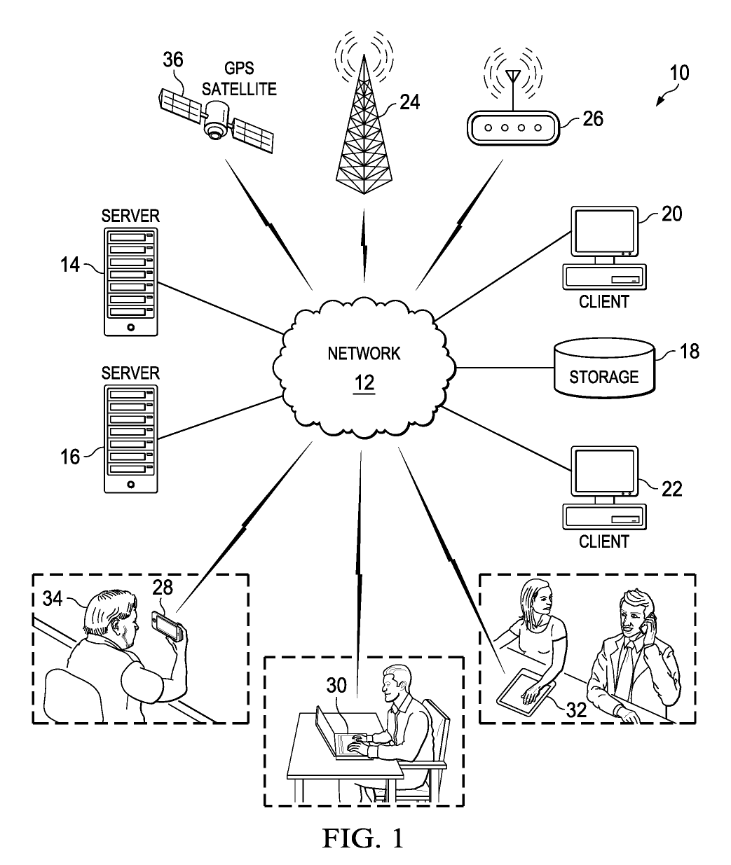

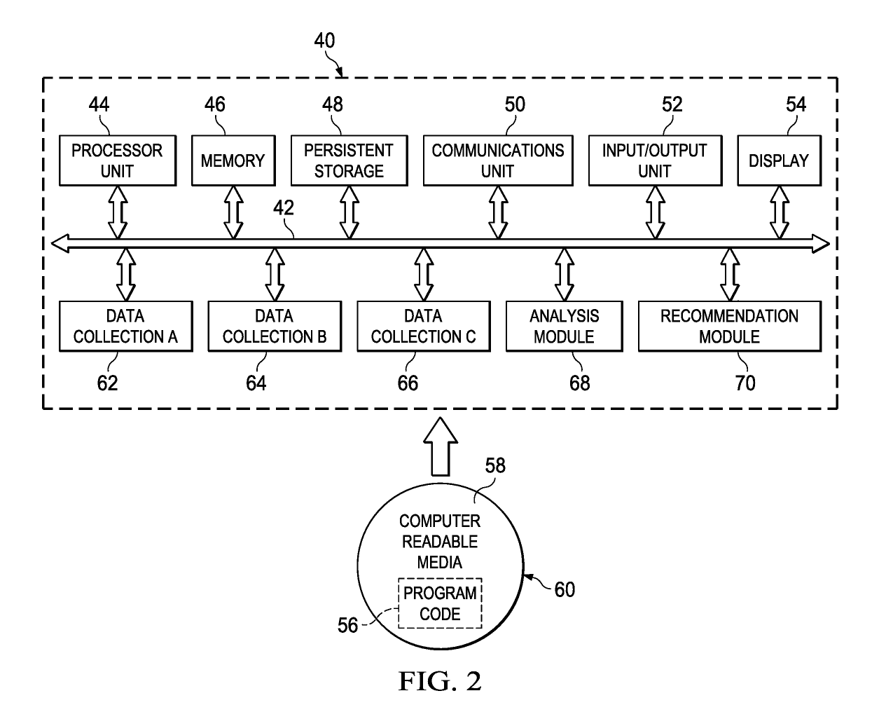

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a representation of a mobile device recommendation system in which illustrative embodiments may be implemented. The mobile device recommendation system 10 may include a network of computers or computing devices. The mobile device recommendation system 10 contains network 12, which is the medium used to provide communications links between various devices and computers connected together within mobile device recommendation system 10. Network 12 may include connections, such as wire, wireless communication links, fiber optic cables, etc.

In the depicted example, server 14 and server 16 connect to network 12 along with storage unit 18. In addition, clients 20 and 22 connect to network 12. Clients 20 and 22 may be, for example, personal or network computing devices. In the depicted example, servers 14 and 16 provide data, such as boot files, operating system images, and applications to clients 20 and 22. Clients 20 and 22 are clients to server 14 in this example. The mobile device recommendation system 10 may include additional servers, clients, and other devices not shown.

Mobile phone (cell) towers 24 and base stations (e.g., Wi-Fi base stations) 26 that facilitate communications and connectivity of mobile devices, such as mobile device 28, with the network 12 and that allow communications between mobile devices, such as mobile devices 30, 32 may also be part of the system 10. In this illustrative example in FIG. 1, mobile device 28 is a mobile phone, such as a smart phone, in the possession of a user 34 to which a recommendation is provided by the system 10 in accordance with the embodiments that are described herein. The mobile device 28 is connected to the network 12, such as through the mobile phone (cell) towers 24 and base stations 26. Additionally, other users of mobile devices, such as mobile devices 30, 32, which may be geographically remote to the mobile device 28 of the user 34, are connected to the network 12 in a similar manner. The mobile devices 28, 30, 32 may also constitute clients, such as the clients 20, 22.

The mobile device recommendation system 10 may also include geographic location determining systems, devices and equipment. These can include GPS positioning devices and equipment, such as GPS satellites or transmitters 36. GPS satellite or transmitters 36 may include one or more satellites or transmitters integrated into a global positioning system that enables mobile devices, such as mobile device 28 to provide geographic location data regarding the location of the mobile device.

The mobile phone (cell) towers 24 and/or base stations (e.g., Wi-Fi base station) 26, with or without the GPS satellites or transmitters 36, may also facilitate determining the geographic location of mobile devices, such as mobile devices 28, 30, 32. The mobile phone towers 24 and base stations 26 for determining the geographic location of a mobile device typically rely on characteristics of the signals transmitted and/or received between the cell tower 24 and/or base station 26, which are at known locations, and the mobile device. The characteristics can include signal strength, angle of approach during movement, time intervals of signals to travel to multiple towers, etc. Using geographic location data, the mobile device recommendation system 10 is capable of determining the geographic location of individual mobile devices, such as mobile devices 28, 30, 32.

Program code located in the mobile device recommendation system 10 may be stored on a computer recordable storage medium and downloaded to a data processing system or other device for use. For example, program code may be stored on a computer recordable storage medium on server 14 and downloaded to mobile devices 28, 30, 32 or clients 20, 22 over network 12 for use thereon.

In the depicted example, the mobile device recommendation system 10 includes the Internet with network 12 including a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the mobile device recommendation system 10 also may be implemented as a number of different types of networks, such as for example, an intranet, a local area network (LAN), or a wide area network (WAN). The recommendation system 10 of FIG. 1 is intended as an example, and not as an architectural limitation for the different illustrative embodiments.

With reference to FIG. 2, a block diagram of a data processing system is shown in which illustrative embodiments may be implemented. Data processing system 40 is an example of a computer or computers, such as servers 14, 16 or clients 20, 22 in FIG. 1, in which computer usable program code or instructions implementing the processes may be located for the illustrative embodiments. In this illustrative example, data processing system 40 provides a platform for the recommendation system and includes communications fabric 42, which provides communications between processor unit 44, memory 46, persistent storage 48, communications unit 50, input/output (I/O) unit 52, and a display 54.

Processor unit 44 serves to execute instructions for software that may be loaded into memory 46. Processor unit 44 may be a set of one or more processors or may be a multi-processor core, depending on the particular implementation. Further, processor unit 44 may be implemented using one or more heterogeneous processor systems in which a main processor is present with secondary processors on a single chip. As another illustrative example, processor unit 44 may be a symmetric multi-processor system containing multiple processors of the same type.

Memory 46 and persistent storage 48 are examples of storage devices. A storage device is any piece of hardware that is capable of storing information, on a temporary basis and/or a permanent basis. Memory 46, in these examples, may be, for example, a random access memory or any other suitable volatile or non-volatile storage device. Persistent storage 48 may take various forms depending on the particular implementation. For example, persistent storage 48 may contain one or more components or devices. For example, persistent storage 48 may be a hard drive, a flash memory, a rewritable optical disk, a rewritable magnetic tape, or some combination of the above. The media used by persistent storage 48 also may be removable. For example, a removable hard drive may be used for persistent storage 48.

Communications unit 50, in these examples, provides for communications with other data processing systems or devices. In these examples, communications unit 50 is a network interface card. Communications unit 50 may provide communications through the use of either or both physical and wireless communications links.

Input/output unit 52 allows for input and output of data with other devices that may be connected to data processing system 40. For example, input/output unit 52 may provide a connection for user input through a keyboard, mouse, touchscreen, gesture commands, voice commands, etc. Display 54 provides a mechanism to display information to a user.

Instructions for the operating system and applications or programs are located on persistent storage 48. These instructions may be loaded into memory 46 for execution by processor unit 44. The processes of the different embodiments may be performed by processor unit 44 using computer implemented instructions, which may be located in a memory, such as memory 46. These instructions are referred to as program code, computer usable program code, or computer readable program code that may be read and executed by a processor in processor unit 44. The program code in the different embodiments may be embodied on different physical or tangible computer readable media, such as memory 46 or persistent storage 48.

Program code 56 is located in a functional form on computer readable media 58 that is selectively removable and may be loaded onto or transferred to data processing system 40 for execution by processor unit 44. Program code 56 and computer readable media 58 form computer program product 60 in these examples. In one example, computer readable media 58 may be in a tangible form, such as, for example, an optical or magnetic disc that is inserted or placed into a drive or other device that is part of persistent storage 48 for transfer onto a storage device, such as a hard drive that is part of persistent storage 48. In a tangible form, computer readable media 58 also may take the form of a persistent storage, such as a hard drive, a thumb drive, or a flash memory that is connected to data processing system 40. The tangible form of computer readable media 58 is also referred to as computer recordable storage media. In some instances, computer recordable media 58 may not be removable.

Alternatively, program code 56 may be transferred to data processing system 40 from computer readable media 58 through a communications link to communications unit 50 and/or through a connection to input/output unit 52. The communications link and/or the connection may be physical or wireless in the illustrative examples. The computer readable media also may take the form of non-tangible media, such as communications links or wireless transmissions containing the program code.

In some illustrative embodiments, program code 56 may be downloaded over a network to persistent storage 48 from another device or data processing system for use within data processing system 40. For instance, program code stored in a computer readable storage medium in a server data processing system may be downloaded over a network from the server to data processing system 40. The data processing system providing program code 56 may be a server computer, a client computer, or some other device capable of storing and transmitting program code 56.

The different components illustrated for data processing system 40 are not meant to provide architectural limitations to the manner in which different embodiments may be implemented. The different illustrative embodiments may be implemented in a data processing system including components in addition to or in place of those illustrated for data processing system 40. Other components shown in FIG. 2 can be varied from the illustrative examples shown.

As one example, a storage device in data processing system 40 is any hardware apparatus that may store data. Memory 46, persistent storage 48, and computer readable media 58 are examples of storage devices in a tangible form.

In another example, a bus system may be used to implement communications fabric 42 and may be comprised of one or more buses, such as a system bus or an input/output bus. The bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 46 or a cache such as found in an interface and memory controller hub that may be present in communications fabric 42.

As shown in FIG. 2, the data processing system 40 may further include data collection modules 62, 64, 66, a data analysis module 68, and a recommendation module 70. Each of the different modules may constitute a software component of the data processing system 40 all or a portion of which is stored in the memory 46 and/or persistent storage 48 and processed by the processing unit 44. In alternate embodiments, the management modules may be a combination of software and hardware. The data collection modules 62, 64, 66 are each used to collect different sets of data that are received over the network 12 in the recommendation system 10. With respect to the data collection modules, data collection module 62 is used to collect ambient sensor data (data set A) from sensors of a mobile devices of a selected population that are located remote from the mobile device of a particular user of the recommendation system. Data collection module 64 is used to collect social media data (data set B) transmitted from and/or related to a plurality of venues and/or events located within a selected geographic area. Data collection module 66 is used to collect data (data set C) from a particular user of a mobile device and/or the mobile device of the user that is to receive a recommendation from the recommendation system 10.

Analysis module 68 may also be stored in memory 46 for analyzing the data sets A, B, and C received by the collection modules 62, 64, 66, respectively. Recommendation module 70 of the data processing system 40 provides a recommendation of at least one of different venues and/or events of a plurality of venues and/or events within a selected geographic area based upon the analyzed data sets A, B, and C from modules 62, 64, 66 and analyzed by the analysis module 68 to provide the recommendation to the mobile device of a particular user.

As previously discussed, the recommendation system and method makes use of the mobile device 28 of a user 34 that receives a recommendation, as well as a plurality of mobile devices, such as mobile devices 30, 32, of a selected population located remote from the mobile device 28 of the particular user 34 that receives the recommendation. The mobile devices that are used in collecting data that is received by the recommendation system will typically have one or more sensors in any combination for providing ambient sensor data that is received by the mobile device recommendation system 10, such as through data collection modules 62, 64, 66.

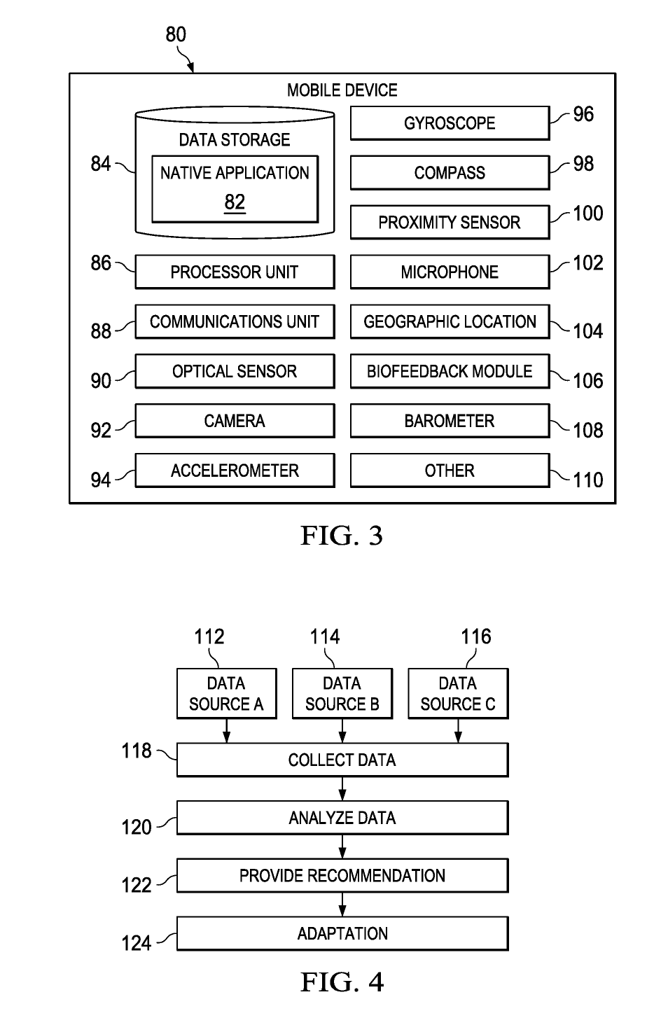

FIG. 3 is a schematic of an exemplary mobile device 80 in which illustrative embodiments may be implemented. In particular, mobile device 80 is representative of a computing device, such as the mobile devices 28, 30, 32 shown in FIG. 1. Moreover, the mobile device 80 can include a data processing system, such as the data processing system 40 or a similar data processing system with all or less than all of the components described with respect to the processing system 40. Further, in this illustrative example in FIG. 3, the mobile device 80 may constitute a smartphone (e.g., iPhone® mobile phone, Android® mobile phone, etc.). In some embodiments, mobile device 80 may be a laptop, a tablet computer, or any other portable electronic computing device having analogous components capable of providing similar functionality.

The mobile device 80 is provided with a client application in the form of a native mobile application 82. The native application 82 may be obtained from an application service provider (ASP) that provides the application software to the mobile device 80 from the recommendation system 10 through the network 12, as previously discussed. The application software may be stored on one or more of the servers 14, 16, which may be operated and maintained by the ASP, or elsewhere within the recommendation system 10. The application 82 may be part of a web-based recommendation system platform wherein functions described herein may be performed on other devices, through either a dedicated application or a web-browser interface. Users may provide login credentials to access and enter information and create user profiles on the recommendation system 10 that is then accessible from any device by providing the same login credentials.

The application 82 may be provided by the ASP either free of charge or for a fee. Furthermore, once the application 82 is purchased, use of the application 82 may be provided free of charge or the ASP may require the user to purchase a subscription or pay a licensing fee, which may be payable on a periodic basis, for the continued use of the application 82 or for access to the recommendation system 10.

As shown in FIG. 3, the native application 82 is stored in data storage 84 of the mobile device 80. The data storage 84 may include memory (RAM) and persistent storage, with all or a portion of the native application 82 being stored on these. A computer processor unit 86 is provided with the mobile device 80 for running programs and processing data. A communications module 88, including hardware and software, that provides communications from and to the mobile device through the use of either or both physical and wireless communications links, and which allows the mobile device 80 to connect to the network 12.

The mobile device 80 is also provided with one or more ambient sensors. As used herein, the expression “ambient sensor” is meant to encompass those devices or components of the mobile device 80 that allow the sensing and collecting of data related to the surrounding environment of the mobile device 80. The native application 82 makes use of these ambient sensors of the mobile device 80 to sense and collect sensor data that is then provided through the network 12 from the mobile device 80 to one or more of the data collection modules 62, 64, 66 of the recommendation system 10.

As shown in FIG. 3, the mobile device 80 includes various ambient sensor modules, which may include both software, hardware, and any necessary devices necessary for sensing and collecting the relevant ambient data. The ambient sensor modules include, but are not limited to, a light or optical sensor module 90, a camera module (which may also function as a light or optical sensor module) 92, an accelerometer module 94, a gyroscope module 96, a compass module (which may be in the form of a digital compass) 98, a proximity sensor module 100, a microphone module 102, a geographic location module 104, a biofeedback data module 106, and a barometric data module 108. Other ambient sensor modules, represented by 110, which may exist currently or come into existence with new technological developments for sensing and monitoring the environment or ambient conditions useful for facilitate recommendations, as described herein, may also be provided with the mobile device 80. One or more of each sensing module may be provided on the mobile device 80. For example, current mobile devices are typically provided with a forward facing camera and a rearward facing camera. Thus, a separate camera module, such as the camera module 92, may be provided for each camera. The sensor modules may each provide a time indication or time and date stamp with the sensor data to provide the time and date when the data was generated.

With respect to the light or optical sensor module 90 this may encompass the use of cameras, such as the camera module 92, as well as other non-camera optical devices. Such non-camera optical devices are those devices that do not necessarily function as a camera for capturing images but are otherwise capable of detecting or sensing light or optical data. The light or optical data include those that are produced from visible and non-visible light. This includes visible light, ultraviolet light, and infrared light. Combinations of different visible and non-visible light may be used as the optical data. In certain instances, the optical device or camera may be a thermographic device that is capable of capturing or detecting thermal optical data or images. In some embodiments, the light or optical sensors 90 may be those devices or sensors that do not necessarily function as a camera for capturing images but rather detect or sense non-image optical data. The light sensor or optical devices may be in the form of devices or sensors that detect, sense, or capture light gradients, contrasting or variations in light or light intensities. This may include visible light, UV light, infrared light, or combinations of these. Non-camera optical devices may be used alone or in combination with a camera or camera.

With respect to the camera module 92, this may be used to collect more than just ambient light or optical data. The camera module 92 may be used to collect both static image and non-static image data, such as videos. Furthermore, camera module 92 may include object recognition software that allows the recognition and identification of certain objects. This may include such things as facial recognition for identify human individuals and which may be general (recognition of a human individual) or specific recognition (recognition of a particular unique and identifiable individual) of such individuals.

The accelerometer module 94 and gyroscopic module 96 typically utilize microelectromechanical systems (MEMS). Such MEMS devices may be 1-, 2-, or 3-axes systems for measuring orientation with respect to 1, 2 or 3 axes of orientation, e.g., pitch, roll and yaw movement. In certain embodiments, a combination of accelerometer and gyroscopic sensors may be used to provide 6-axes or even 9-axes of orientation of the mobile device 80. These modules allow the detection of movement of the mobile device 80. Software programs that allow the interpretation of different movements and activities can be provided with these modules or those of those of the recommendation system so that a particular activity can be determined, such as walking, running, dancing, jumping, etc.

The digital compass module 98 may include magnetometer for providing orientation data with respect to the Earth's magnetic field.

The proximity sensor 100 may include various technologies that enable detection of objects without physical contact. These may include those based upon the emission and detection of infrared (IR) light as well as other methods.

The microphone data module 102 may make use of the mobile phone's built-in microphone (used for communications) or a different microphone and can include software that provides instructions on when the microphone should be activated and when audio data is collected, such as with the use of the recommendation system.

The geographic location module 104 may be that which utilizes the GPS satellites or transmitters 36 (FIG. 1) and/or mobile phone towers 24 and base stations 26 that facilitate providing data related to the geographic location of the mobile device. The module may include antennas, software, and other devices to facilitate determining the geographic location of the mobile device 80. The geographic location module 104 may also be used in mapping software for rendering maps and determining locations, which may be displayed on the displays of the mobile devices.

Biofeedback data module 106 may be provided for providing data related to a particular individual associated with the mobile device 80. This may include such things as heart rate, respiratory rate, body temperature, blood pressure, etc. In many instances, the mobile device 80 may be coupled to or in communication (e.g., Bluetooth® wireless) with a separate biofeedback device (not shown) that is separate from the mobile device 80. This may include a wristwatch or bracelet that is worn by the user of the mobile device.

The barometric data module 110 may include those digital barometers that are presently found on some smartphones.

Referring to FIG. 4, a flow diagram is shown that illustrates process steps used in exemplary embodiments. As shown, data from data sources 112, 114, 116 is collected at 118, such as through data collection modules 62, 64, 66 of processing unit 40 of FIG. 2. Data source 112 provides data set A that comprises ambient sensor data from sensors of mobile devices, such as the mobile devices 30, 32, of a selected population located remote from the mobile device 28 of a particular user, such as user 34. The data set A is collected over the network 12. The sensor data can be any sensor data collected from the mobile devices from any one or more of the ambient sensor modules described previously. This can include sensor data from the light or optical sensor module 90, the camera module 92, the accelerometer module 94, the gyroscope module 96, the compass module 98, the proximity sensor module 100, the microphone module 102, the geographic location module 104, the biofeedback data module 106, the barometric data module 108, or the ambient sensor module 110. The collection of sensor data from the mobile devices, such as mobile devices 28, 30, 32, may be enabled by operation and running of the native application 82 that is provided by the ASP, as described previously, on the mobile device.

As non-limiting examples of the sensor data of data set A that is collected at 16, this may include light or optical data that indicates whether a venue is dark or well lit. A photograph or video taken with the camera can provide metadata that can be collected and analyzed and provide an indication of the characteristics of the venue and what is taking place. Movement data from the accelerometer and gyroscope of mobile devices can be used to determine whether there is active movement, such as dancing, or whether people are relatively stationary at the venue. Audio data from the microphone can be collected and analyzed to determine noise characteristics and noise levels. This can be used, for example, to determine if quite or loud conversations are occurring, whether music is being played, the types or particular music being played, etc. From biofeedback, the physical state of individuals at venues and/or events can be determined. This may include biofeedback data that indicates that the individuals are excited or active, which may be indicated by an elevated pulse rate, or whether they are calm or inactive, which may be indicated by a low pulse rate.

In certain embodiments, the sensor data may be that from at least one mobile device of another that is identified as a “friend” of the user 34, as the user may have designated through one or more applications or on the native application 82, which may pull or rely on identified friends from other sources or applications, such as a mobile device's contacts database.

Data source 114 provides data set B that comprises social media data transmitted from and/or related to a venues and/or events located within a selected geographic area. Data source 114 may be collected through collection module 64 of data processing unit 40. The recommendation system 10 can make use of HTTP and REST APIs, as well as data feeds, and other sources, in collecting the social media data.

The social media data may be that generated from a variety of sources. These may be provided to the recommendation system from both licensed and publically available data that may be available from third party sources. These may include commercial sources, such as entertainment companies or entities (e.g., CBS, ESPN, Sony Music, artists, bands, musicians, performers, etc.), venue owners or managers (e.g., owners or managers of restaurants, bars, arenas, galleries, concert halls, coffee shops, etc.), and third party sources that collect information and data related to various entities, venues, events, etc. This may include both advertising data and non-advertising social media data that are generated by the commercial sources. Other social media that may be provided from external sources can include social media platforms, such as Twitter, Facebook, Instagram, etc.

The social media data may include event information and metadata, location information and metadata, and geo-specific social media content. Location information for venues, events, etc., may be used and correlated with mapping software of the geographic location module 104 so that the locations of various venues, events, etc. may be displayed with maps generated on the displays of the mobile devices.

Furthermore, the social media data may be generated from the recommendation system itself wherein the recommendation system includes its own social media platform provided to the users, such as through the application 82 or through other web-based interfaces. The recommendation system social media platform may allow interactions with other users of the recommendation system and can include the selection or designation of particular “friends” or other designations of particular users, and allow the formation of communities or networks with other users, such as those having common interests. The social media platform may also facilitate the internal creation, sharing and exchanging of information between users, such as through forums, messaging, message boards, blogs, wall postings, text, image and video sharing, etc. In certain embodiments, the third party social media may be provided within the recommendation system social media platform. Third parties may be allowed to post or provide social media data, such as advertising, within the recommendation system social media platform. Such social media data provided by commercial third party sources may be fee based, wherein the third party pays a fee to post such social media, or it may be free of charge.

Data set B may be social media data that originates and is transmitted from within a particular selected geographic area by devices utilizing the recommendation system, as may be determined by using the geographic location modules 104 of the mobile devices. Data set B may also include social media data that is transmitted or provided from a source outside a particular selected geographic area but that may relate to particular venue and/or event that is located within a particular selected geographic area. For example, the owner of a chain of entertainment venues around the country may have a particular event that is occurring at a particular venue that is within the selected geographic area and thus provides social media data related to the event occurring at the venue. Although, the social media that is generated and transmitted by the owner of the entertainment venues may originate from a geographic location that is outside the selected geographic area it still relates to the selected geographic area and is thus relevant to the recommendation system and method in providing a recommendation of a particular event or venue within the selected geographic area.

Data source 116 provides data set C that comprises data received from the user 34 of a mobile device 28 for which the recommendations are provided by the recommendation system. The data can comprise data generated by the user 34 on the mobile device 28 or on other devices or systems that form the recommendation system platform. The data may be entered by the user 34 on the mobile device through the native application 82 or client application or other applications on the mobile device 28 that interact with the recommendation system. This can include user profile information that is entered into the system by the user's actions. This may be in the form of preferences or dislikes that the user may directly enter into the system by the user. The user may define a selected geographic area for venues and/or events that the user is interested in obtaining a recommendation, or a particular type of venue and/or event within a selected geographic area. The user may also generate social media data on the mobile device or through the recommendation system, posting messages or information about particular venues or events. The user's interactions on the system may also relate to local events and/or venues, the user's interactions with other profiles (e.g., profiles for businesses, entertainment entities, venues, etc.), advertising, and social media data, how long a user may review a particular page or site accessed through the system, positive or negative actions that may be taken on a particular page or site by the user, etc. The user's social media usage may also be collected. Information, including positive and negative information, which the user posts or transmits through social media or the recommendation system may be collected for analysis.

While data may be entered by the user 34 directly on the mobile device through the native application 82, client application or other applications on the mobile device 28 that interact with the recommendation system, the data received from the user may also be data received from the mobile device 28 of the user 34 without active input by the user. This will typically be provided by ambient sensors of the mobile device, such as those described for the mobile device 80. Of particular relevance is the geographic location data of the mobile device 28, such as provided by the geographic location module 104, of the user that provides an indication of the user's current and past locations. The collected ambient sensor data of the user may also include non-location ambient data. This may include light or optical data, movement data (i.e., such as measured by accelerometer or gyroscope), audio data, bio-feedback data, etc. This data can be used to determine the user's current location to determine particular venues or events for recommendation that are within a selected geographical area that is nearby to the user's present location. The collected data may also be identified by time or be provided with a digital time and date stamp to indicate when the data was generated. This data can provide an indication of the types of venues or events the user frequents or avoids, thus indicating the user's tastes and preferences. This may include indication that the user likes either well lit or dark venues, loud or quite venues, particular types of music being played at venues or events, whether the venue provides a calming or exciting atmosphere as measured by biofeedback, whether there is movement (e.g., dancing) by the user or the user remains stationary, etc. By providing a time identification or timestamp with the generated data, it may be possible to determine that the user prefers certain venues or events at certain days or times but avoids them at other days and times.

The collected data 16 may be stored in a logical and easily accessible datastores, such as the servers 14, 16. These may be stored perpetually or for long periods of time. By collecting and storing data from each of the data sources 112, 114, 116 a history is provided that enables a recommendation tailored to a particular user.

As shown in FIG. 4, the collected data 118 from the data sources 112, 114, 116 is then analyzed at step 120. In the analysis step 120, the data from collected data 118 is processed to gain insights in the data and present a recommendation to the user that optimizes the use of the mobile device in providing a recommendation 122. In particular, the data is analyzed to provide a recommendation of venues and/or events to a user based upon the analyzed collected data. This recommendation will typically be venues and/or events within a selected geographic area that may be close to the current sensed geographic location of the mobile device 28 (FIG. 1) of the user 34 or that the user may actively enter into the recommendation system as being the geographic area that the user desires a recommendation.

In analyzing the data, the analysis is geared toward answering the question of what would be the best venues and/or events to recommend for a particular user based upon all the collected data at any given moment. The aggregated data may be qualitatively analyzed through natural language processing (NLP), machine learning, advanced probability and linear algebra, Bayesian statistics, automata mathematics, and other advanced computational and mathematical techniques and combinations of these. Those analyzing techniques and programming methods discussed and described in Bradley, P. S., et al., “Mathematical Programming for Data Mining: Formulations and Challenges,” Journal on Computing 11, 1999, 217-238, which is incorporated herein by reference in its entirety for all purposes, may be used. The analysis of textual content may take the form of sentiment analysis wherein the analysis involves an understanding of what subjects users are talking about and qualitatively what they are saying about the subjects is made. For images and video, this may involve identifying what is occurring or what objects are in the image or video and generating new metadata related to it. By understanding what the topics of social conversation are in social media at a selected location or related to a selected location, such as identifying a location that is mentioned in social media content, and understanding the qualities and characteristics ascribed to the location, the recommendation system can provide an understanding of that venue or event that cannot be achieved without the recommendation system.

By analyzing the collected data, a “sense” for what is occurring around a user or users can be made at any given time. The system can make a determination about what specific activities are engaged in at a particular venue or event in substantially real time. In certain instances, the system may be provided with examples or templates of data that correlate to certain behaviors. Thus, data associated with running, dancing, lounging at a table, sitting at a bar, etc., can be ascertained. The system may utilize Bayesian networks, for example, to do this. A Bayesian network is a probabilistic graphical model, which is a type of statistical model that represents a set of random variables and their conditional dependencies via a directed acyclic graph. In the present application, the model is used to define what data resembles specific behaviors. By aggregating and analyzing the collected data, such as ambient sensor data from users of the recommendation system, the system can determine how closely it resembles these models and determine the statistical likelihood users are engaging in a known activity for which a model is created for any given location or event.

Current ambient sensor data from sensors of mobile device that are currently located within the selected geographic area at different venues and events are used to allow the system to know what is going on at a particular venue or event at any given time. Current ambient sensor data used by the recommendation system in providing a recommendation may be data that was transmitted within minutes (e.g., 1 min, 2 min, 3 min, 4 min, 5 min, 10 min, 15 min, 20 min, 25 min, or 30 min) or even seconds from the mobile devices and will typically not be more than a few hours old. The time delay for current ambient sensor data being collected may be affected by its availability. For example, if no sensor data is collected for a period of time for various reasons, the recommendation system may rely on the most recent collected data in its analysis as constituting current ambient sensor data. A selected time interval may be selected where the ambient sensor data is considered too old or stale so that it is not used or classified as being current. The selected time interval where the data may be considered as being current may vary depending on the type of sensor data being collected. For example, geographic location data of mobile devices of friends may be considered stale or no longer current if it is more than a few minutes old (e.g., more than 5 min). This is to improve reliability and ensure that false indications of a friend's whereabouts are not provided by the recommendation system to a user. Historical or past ambient surrounding sensor data from sensors of mobile device that were located within the selected geographic area in the past may also be used in the analysis, however. Patterns using both current and historical sensor data can be ascertained that over time can increase the reliability of the analysis.

The analysis is further facilitated by coupling the sensor data (data set A) with collected social media data (data set B) that indicates what user's and others are saying about a particular venue or event. The social media data may be current social media data that is no more than a few hours old. In specific embodiments, the current social media data may be 1 hour, 2 hours, 3 hours, 4 hours, 5 hours, or 6 hours or less. This can be positive social media data, i.e., positive things are being said about a particular venue or event, or negative social media data, i.e., negative things are being said about a particular venue or event. This social media data can be cross referenced with the sensor data. The system can therefore have an accurate understanding of what is going on at a particular venue in real time and what people's attitudes are about it. In certain embodiments, sensor data and social media data from a particular user's friends may be used or the data from the user's friends may be weighted to give the data received from friends a greater or different weight in the analysis. The current location of a user's friends may also be collected and analyzed. Historical or past social media data originating from locations within the selected geographic area in the past may also be used in the analysis. Patterns can be ascertained that over time can increase the reliability of the analysis.

The collected data from data set C is also analyzed in providing a recommendation. As discussed, preferences and data history of a user may be used in the analysis. This may include past sensor data of the mobile device of the user as well as preferences that the user enters into the system and social media data generated by the user. Similar techniques, such as the mathematical and statistical methods discussed previously, for analyzing the data collected from the user may also be employed in analyzing data set C. In this way the recommendation system can analyze the data from the user to determine what types of venues or events would most likely be enjoyed by the user or provide a positive experience for the user at any given time within a selected geographical area.

By coupling or correlating the analyzed data from the user (data set C) with the analyzed ambient sensor data (data set A) and the social media data (data set B), the recommendation system can generate appropriate recommendations in step 122 to the user of what the user might currently enjoy within the selected geographic area. This may be in the form of recommendations for one or more venues and/or events in the selected geographic area. Different models generated for the user during the analysis may be applied and correlated with other received data based upon different variables to provide the recommendations. These variables may include, but are not limited to, the day of the week, time of day, geographic location of the user, geographic location of the user's friends, geographic locations of other users that have similar preferences, mood of the user as determined by biofeedback, recent social media generated by the user, preferences recently entered by the user, etc.

Once the recommendations have been made, a further step of adaptation 124 may be made. Once a recommendation has been made by the system, the user may accept or reject the recommendation. This may be made directly by the user on the user's device or may be ascertained indirectly, such as by geographic location data received from the user's mobile device that indicates that the user has moved to one of the recommended venues or events. Likewise, the system can ascertain that the user did not accept a recommendation by geographic location data received from the user's mobile device that indicates the user did not move to the recommended venues. Data of how the user responded to the recommendations can be further collected and used in further adapting and tailoring the recommendation system to the particular user. For those recommendations the user accepts or does not accept, the recommendation system can further analyze the different variables of the collected and analyzed data and how the user reacted to provide new models that may be more accurate and provide better recommendations. This allows the recommendations provided by the recommendation system to be improved over time.

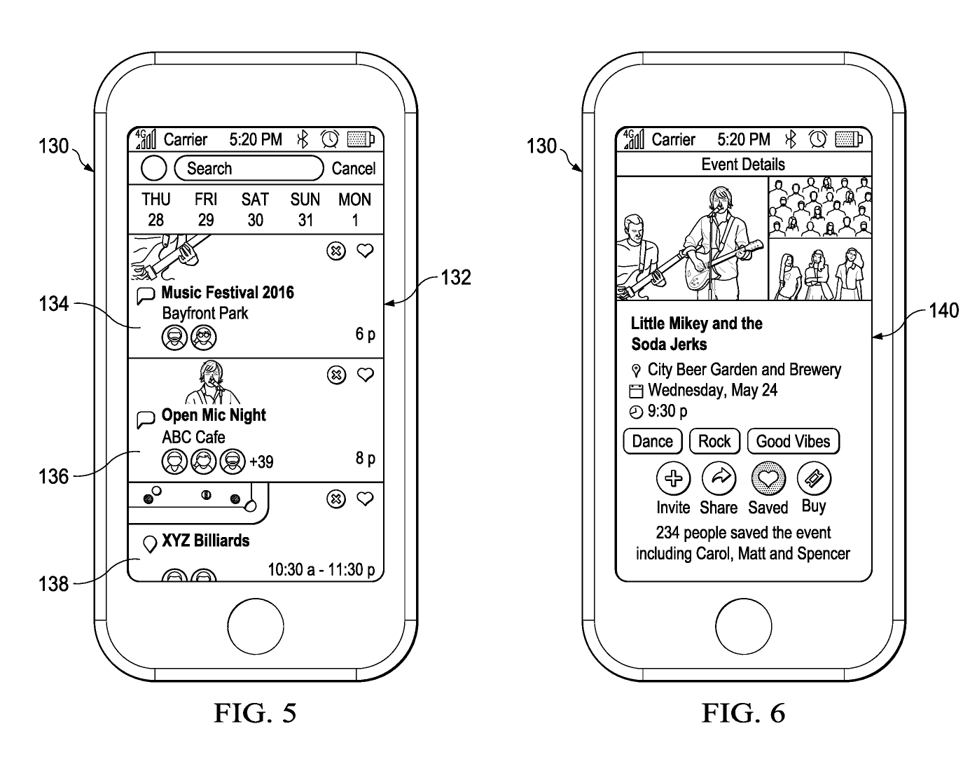

Part of the recommendation system that users interact with is the client application. This takes the form of a native application, such as the native application 82 (FIG. 3), provided on the mobile device. FIGS. 5-9 show an exemplary mobile device or smart phone 130 that shows examples of screen displays provided by the native application. As shown in FIG. 5, the client application can be provided with an “explore” screen 132 displayed on the display, which may be in the form of a touchscreen, of the mobile device 130. The explore screen 132 contains a personalized list of recommendations of events, venues, and activities, which may be in the form of tiles 134, 136, and 138. These tiles may be the product of the recommendation provided by the recommendation system utilizing the methods, systems, and devices that have been previously described. These tiles can be tapped or otherwise launched by the user to allow them to review a details screen 140 on the device 130 about the event, as shown in FIG. 6.

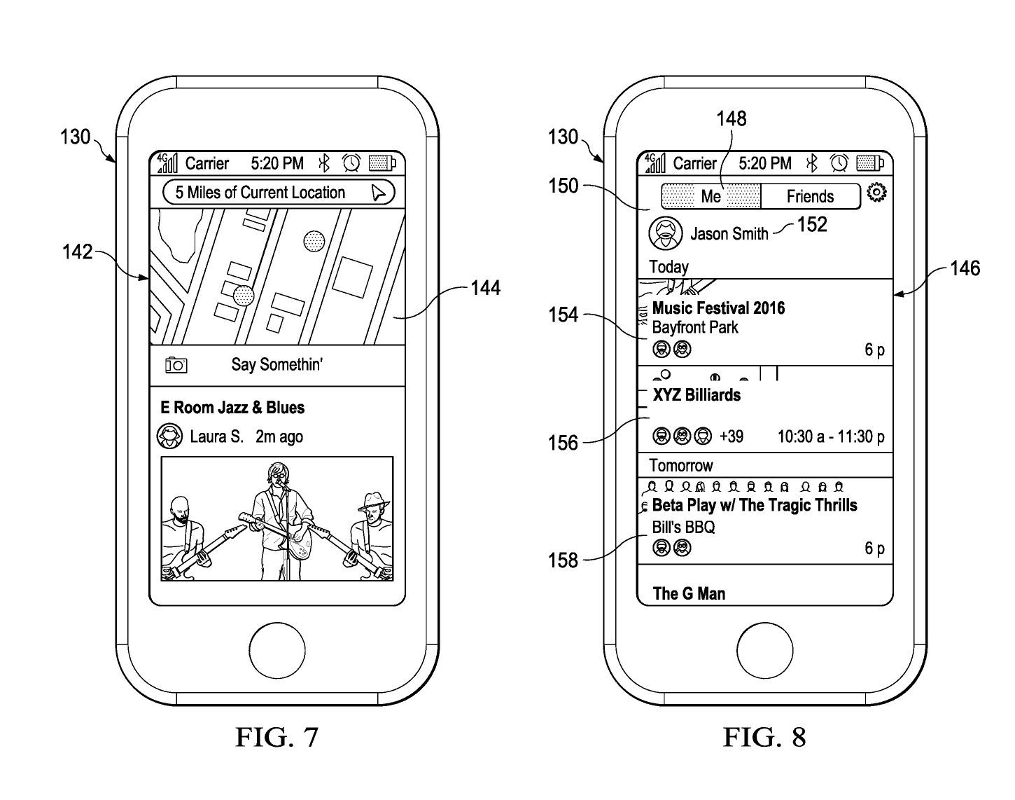

Referring to FIG. 7, in an aspect of particular embodiments the client application may provide a social media feed screen 142 on the display of the mobile device 130. The social media feed screen 142 provides an overview of the nearby ambient social media dialogue. This allows users direct access to the social dialogue going on around them within a selected geographic area. The social dialogue may be that produced internally within the recommendation system itself or may be sourced from other outside social media platforms (e.g., Twitter, Instagram, etc.). A map 144 may be generated on the screen 142 that a user can scroll or access different areas of the geographic area represented on the map and see what is being said on social media in those areas. In addition to being a channel for users to review geo-specific social media conversations, the user can also join in the conversation and generate or post their own experience, thoughts, and opinions about what is going on in their geographic location through the recommendation system. This provides a large source of social media data to the recommendation system and further allows it to analyze the collected data and make useful recommendations about venues and/or events within selected geographic areas in substantially real time.

In still another aspect of certain embodiments, the client application may provide a collections screen 146 on the display of the mobile device 130, as shown in FIG. 8. The collections screen 146 allows users to save information regarding venues or events and locations that have an interest. A user selection icon 148 launches a user page 150 on the collections screen 146 with a user identifier 152. The user page 150 is shown along with saved venues or events, shown as tiles 154, 156, 158. Touching or accessing the tile 154, 156, 158 for the individual venue or event may launch a page (not shown) with detailed information about each saved venue or event.

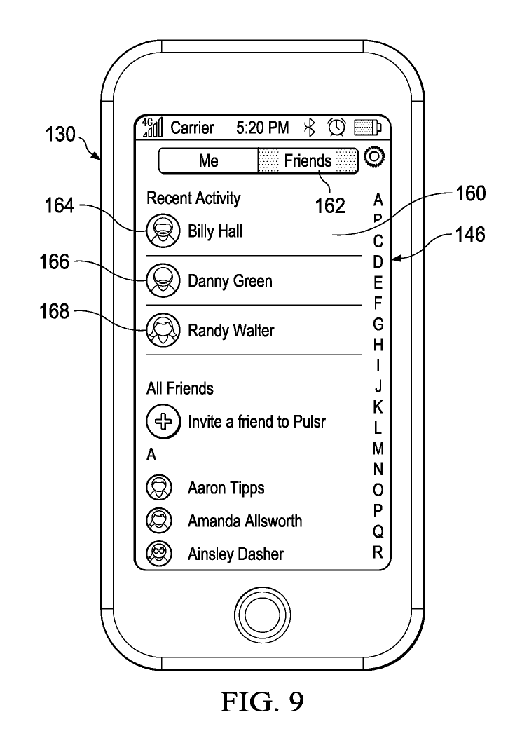

The collections screen 146 also allows the user to coordinate with their friends on what events and locations they would like to attend. FIG. 9 shows a friends page 160 that may be accessed by selecting a friends icon 162 on the collections screen 146. As shown, tiles 164, 166, 168 for each friend are provided on the friends page 160. By selecting one of the friend tiles, a friend's collections page (not shown), which may be similar to the user page 150, can be launched where the friend's saved collections are displayed.

The following description provides an example of use of the recommendation system. In use, a user in a particular geographic location may decide that they want to find something to do in the area nearby. The user may have a mobile device or smart phone with the native application for the recommendation system loaded on the user's device or phone. Based upon prior use, the recommendation system has already collected data on certain places or events the user has gone or attended. This is based upon detecting the location of the user's device through geographic location data that has been collected through the geographic location determining systems, as previously described. Moreover, the recommendation system has collected data on how the user has reacted to prior recommendations the system has made, as well as any information the user has entered into the system relating to the user's preferences. Based upon this, the recommendation system knows the user likes particular venues, such as divebars. The recommendation system has determined this specific preference because data related to the user's mobile device location has been collected that is associated with these types of venues. Furthermore, data regarding the location of the mobile phones of the user's friends, who also are using the recommendation system, has been collected and shows that they have or are attending the same or similar locations.

To obtain a recommendation, the user launches the native application on the user's phone or device. The recommendation system determines the user's geographic location and determines venues and events within a selected geographic area surrounding the user's location. The recommendation system analyzes the data it has collected that is related to the selected geographic area with respect to venues and/or events that have taxonomical information that they are similar to divebars. As discussed previously, this taxonomical information may be sourced from third parties, however, the most accurate information may be derived from users of the recommendation system. This includes the historic and current actions of users at locations within the selected geographic area, geo-specific social media posts, and ambient sensor data transmitted from multiple mobile devices of users located at or that have been located at various venues and/or events within the selected geographic area.

Because the data collected from the ambient sensors of a user's mobile device while using the recommendation system may occur during a specific set of behaviors, i.e., using the system while engaging in the social landscape around them, a very specific set of information can be collected and used for providing recommendations that more general recommendation systems are unable to provide.

As an example, users referencing a particular location through the social media component of the recommendation system, such as accessed through the social media feed screen 142 (FIG. 7), may describe a particular location as a “pool hall” or “local watering hole.” The ambient light and noise levels as measured by ambient sensors and collected by the system may also be statistically similar to other venues that are known “divebars.” The recommendation system may then find, for example, 200 potential recommendation venue or event candidates within the selected geographic area that fit in this category that it will further analyze before providing a recommendation.

By collecting and analyzing the dialogue generated through social media the recommendation system has collected from third party sources, such as Twitter, Instagram, etc., and from internal social media content generated through the recommendation system, the recommendation system determines what others are saying about the venue or event candidates. In particular, the system recognizes the geographic location from which the social media is generated and transmitted using the system's geographic location system and whether it is close to one of the venue or event candidates. Furthermore, the recommendation system also looks for keywords contained in posted text or metadata known to be associated with various locations using a statistical classifier (e.g., Naive Bayesian). This allows the recommendation system to score how statistically likely it is that a particular social media post is talking about a given potential recommendation candidate. The recommendation system then looks at whether positive things have been mentioned about the recommendation candidates in the last few hours. This may be accomplished using natural language processing and Bayesian statistical models that look at sentiment related keywords. Negative mentions in social media posts may also be analyzed in a similar manner.

Upon analysis, the recommendation system may find 15, for example, of the recommendation candidates have been spoken of with a positive sentiment and little negative sentiment in the last few hours. This narrows down the list of candidates so that the recommendation system can eliminate the remaining candidates as recommendations.

The user's past use has also indicated that the user does not enjoy dancing. This may be determined through the user's past interactions with the recommendation system's recommendations that are known to involve or be related to dancing. In the past, the recommendation system has recommended places where dancing occurs, and the user has not visited these venues or has taken explicit negative actions on the recommended items.

The recommendation system may also utilize the ambient sensor data, both current and historic, that is collected from the other user's mobile devices to see what is occurring at the remaining venues. These venues will typically be those that are remote from the user and not in the user's immediate vicinity where the user would be able to determine by personal observation what is occurring. This may be a remote venue that is across or down the street, a few blocks away, or across town, etc. The ambient sensor data may provide the type of movements and ambient sounds that are occurring or have historically occurred with the remaining recommendation candidates. By analyzing this data, such as through Bayesian networks representing the output of sensors during certain activities, the recommendation system may conclude that dancing is likely occurring at five of the recommendation candidates for divebars. This narrows the recommendation candidates to ten potential divebars.

The user may also prefer low key evenings, which is known by the recommendation system because the user has reacted positively on the system to this, but the user also does not want to attend venues or events where there are too few people or little activity. The recommendation system reviews the current and historic ambient social media data with respect to the remaining recommendation candidates, as well as ambient sensor data, received from users attending these places. In this way, the recommendation is able to further characterize the remaining recommendation candidates and eliminate another five recommendation candidates for recommendations. This leaves five recommendation candidates that have a high chance of having the mood and atmosphere that the user prefers.

In an additional analysis, the recommendation may also look at where the user's friends are that are using the recommendation system and have connections to the user within the selected geographic area. The recommendation system sees that a few of the user's friends are in the area at three of the remaining five locations. Thus, the user's friends may already be at the locations or can quickly meet the user there. As a result, the recommendation system can confidently recommend those remaining three locations as being divebars that the user will likely enjoy.

As can be seen, the recommendation system has taken into account a variety of different data and provided a limited number of recommendations that would be considered the most enjoyable to the user. The venues fit the user's taste or preferences, people on social media are speaking positively about the locations within the last few hours, no activities the user dislikes are occurring there, the mood appears to match the user's preference, and the user's friends are at or nearby the locations.

While the above description provides an example of the use of the recommendation system, the exact sequence may vary. Moreover, much of the analysis and calculations will be taking place simultaneously. In fact, much of it may occur before the user even opens the native application on the user's mobile device.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

We claim:

1. A method of providing recommendations with a mobile device recommendation system to a user of a mobile device comprising:
collecting data set A with the mobile device recommendation system over a network wherein data set A comprises ambient sensor data from sensors of a plurality of mobile devices of a selected population located remote from the mobile device of the user;
collecting data set B with the mobile device recommendation system over the network wherein data set B comprises social media data transmitted from and/or related to a plurality of venues and/or events located within a selected geographic area;
collecting data set C with the mobile device recommendation system over the network wherein data set C comprises data received from the user of the mobile device and/or the mobile device of the user;
analyzing data sets A, B, and C with the mobile device recommendation system; and
providing a recommendation of at least one of the venues and/or events of the plurality of venues and/or events within the selected geographic area based upon the analyzed data sets A, B, and C from the mobile device recommendation system to the mobile device of the user.

2. The method of claim 1, wherein:
at least a portion of the ambient sensor data from sensors of the plurality of mobile devices in data set A is obtained from at least one sensor that is located at at least one venue and/or event located within the selected geographic area of data set B.

3. The method of claim 1, wherein:
the mobile device recommendation system includes an application accessed on the mobile device of the user and at least one other mobile device of the selected population, and wherein at least one of the collected data sets A, B, and C is collected through the application of at least one of said mobile device of the user and said at least one other mobile device of the selected population.

4. The method of claim 1, wherein:
wherein the data set A includes ambient sensor data from sensors of mobile devices that are located within the selected geographic area.

5. The method of claim 1, wherein:
data set C includes location data of the mobile device of the user and wherein the selected geographic area of data set B is selected based upon the location data of the mobile device of the user.

6. The method of claim 1, wherein:
the sensor data includes at least one of ambient light sensor data, camera data, accelerometer data, gyroscopic data, digital compass data, proximity sensor data, microphone data, geographic location data, biofeedback data, and barometric data.

7. The method of claim 1, wherein:
analyzing data sets A, B, and C with the mobile device recommendation system includes analyzing past location data of the mobile device of the user over a selected period of time collected as part of data set C.

8. The method of claim 1, wherein:
collecting at least one of data sets A and B includes collecting at least one of sensor data and social media data transmitted from at least one mobile device of another that is identified as a friend of the user.

9. The method of claim 1, wherein:
analyzing data sets A, B, and C with the mobile device recommendation system includes analyzing at least one of 1) collected past sensor data of the mobile device of the user, 2) preference data collected from the user, 3) collected positive social media data, 4) collected negative social media data, 5) past ambient sensor data from sensors of mobile device that were located within the selected geographic area in the past, 6) current ambient sensor data from sensors of mobile device that are currently located within the selected geographic area, and 7) current location data of at least one mobile device of another that is identified as a friend of the user.

10. The method claim 1, wherein:
collecting data set B includes collecting social media data transmitted from the selected geographic area.

11. The method of claim 1, wherein:
collecting data set B includes collecting social media data related to the plurality of venues within the selected geographic area that are received from third-party sources.

12. A mobile device recommendation system for providing recommendations to a user of a mobile device comprising:
a computing system having a memory and a processer, the computing system being coupled to a network for transmitting and receiving data to and from the computing system, the computing system having a set of modules stored on the memory and processed by the processor, the modules comprising:
a data set A collection module that receives a data set A over the network wherein data set A comprises ambient sensor data from sensors of a plurality of mobile devices of a selected population located remote from the mobile device of the user;
a data set B collection module that receives a data set B over the network wherein data set B comprises social media data transmitted from and/or related to a plurality of venues and/or events located within a selected geographic area;
a data set C collection module that receives a data set C from the user of the mobile device and/or the mobile device of the user;
an analysis module that analyzes data sets A, B, and C; and
a recommendation module that provides a recommendation of at least one of the venues and/or events of the plurality of venues and/or events within the selected geographic area based upon the analyzed data sets A, B, and C analyzed by the analysis module to the mobile device of the user.

13. The system of claim 12, wherein:
wherein at least one of the collected data sets A, B, and C is collected through an application of at least one of said mobile device of the user and said at least one other mobile device of the selected population.

14. The system of claim 12, wherein:
wherein the data set A includes ambient sensor data from sensors of mobile devices that are located within the selected geographic area.

15. The system of claim 11, wherein:
data set C includes location data of the mobile device of the user and wherein the selected geographic area of data set B is selected based upon the location data of the mobile device of the user.

16. The system of claim 12, wherein:
the sensor data includes at least one of ambient light sensor data, camera data, accelerometer data, gyroscopic data, digital compass data, proximity sensor data, microphone data, geographic location data, biofeedback data, and barometric data.

17. The system of claim 12, wherein:
analyzing data sets A, B, and C with the mobile device recommendation system includes analyzing past location data of the mobile device of the user over a selected period of time collected as part of data set C.

18. The system of claim 12, wherein:
collecting at least one of data sets A and B collected by the data set A collection module and the data set B collection module includes at least one of sensor data and social media data transmitted from at least one mobile device of another that is identified as a friend of the user.

19. The system of claim 12, wherein:
the analysis module analyzes at least one of 1) collected past sensor data of the mobile device of the user, 2) preference data collected from the user, 3) collected positive social media data, 4) collected negative social media data, 5) past ambient sensor data from sensors of mobile device that were located within the selected geographic area in the past, 6) current ambient sensor data from sensors of mobile device that are currently located within the selected geographic area, and 7) current location data of at least one mobile device of another that is identified as a friend of the user.

20. The system claim 12, wherein:
the data set B collection module collects social media data transmitted from the selected geographic area.

21. A computer program product for a mobile device recommendation system for providing recommendations to a user of a mobile device, the computer program product comprising:
a non-transitory computer readable medium storing program instructions comprising:
data set A collecting instructions for collecting a data set A with the mobile device recommendation system over a network wherein data set A comprises ambient sensor data from sensors of a plurality of mobile devices of a selected population located remote from the mobile device of the user;
data set B collecting instructions for collecting a data set B with the mobile device recommendation system over the network wherein data set B comprises social media data transmitted from and/or related to a plurality of venues and/or events located within a selected geographic area;
data set C collecting instructions for collecting data set C with the mobile device recommendation system over the network wherein data set C comprises data received from the user of the mobile device and/or the mobile device of the user;
analyzing instructions for analyzing data sets A, B, and C with the mobile device recommendation system; and
recommendation instructions for providing a recommendation of at least one of the venues and/or events of the plurality of venues and/or events within the selected geographic area based upon the analyzed data sets A, B, and C from the mobile device recommendation system to the mobile device of the user.

22. The computer program product of claim 21, wherein:
at least one of the collection instructions for collecting data sets A, B, and C is instructions for collection of the data set through an application of at least one of said mobile device of the user and said at least one other mobile device of the selected population.

23. The computer program product of claim 21, wherein:
wherein the data set A includes ambient sensor data from sensors of mobile devices that are located within the selected geographic area.

24. The computer program product of claim 21, wherein:
data set C includes location data of the mobile device of the user and wherein the selected geographic area of data set B is selected based upon the location data of the mobile device of the user.

25. The computer program product of claim 21, wherein:
the sensor data includes at least one of ambient light sensor data, camera data, accelerometer data, gyroscopic data, digital compass data, proximity sensor data, microphone data, geographic location data, biofeedback data, and barometric data.

26. The computer program product of claim 21, wherein:
the analyzing instructions for analyzing data sets A, B, and C include analyzing past location data of the mobile device of the user over a selected period of time collected as part of data set C.

27. The computer program product of claim 21, wherein:
collection instructions for collecting at least one of data sets A and B includes collecting at least one of sensor data and social media data transmitted from at least one mobile device of another that is identified as a friend of the user.

28. The computer program product of claim 21, wherein:
the analyzing instructions for analyzing data sets A, B, and C includes analyzing at least one of 1) collected past sensor data of the mobile device of the user, 2) preference data collected from the user, 3) collected positive social media data, 4) collected negative social media data, 5) past ambient sensor data from sensors of mobile device that were located within the selected geographic area in the past, 6) current ambient sensor data from sensors of mobile device that are currently located within the selected geographic area, and 7) current location data of at least one mobile device of another that is identified as a friend of the user.

29. The computer program product claim 21, wherein:
data set B collection instructions includes collecting social media data transmitted from the selected geographic area.
